(19) United States
(12) Patent Application Publication
(10) Pub. No.: US 2006/0027189 A1
(43) Pub. Date: Feb. 9, 2006

(54) Leash, in particular for leading horses or dogs

(76) Inventor: Josef Luber, Schaittenbach (DE)

Correspondence Address: HOFFMAN, WASSON & GITLER, P.C., Crystal Center 2, Suite 522, 2461 South Clark Street, Arlington, VA, 22202, US

(21) Appl. No.: 11/187,922

(22) Filed: Jul. 25, 2005

(30) Foreign Application Priority Data
Jul. 27, 2004 (DE) 20 2004 011 756.8
Apr. 29, 2005 (EP) 05 009 402.8

(51) Int. Cl. A01K 27/00

(52) U.S. Cl. 119/795

(57) ABSTRACT

The invention relates to a leash that is particularly suitable for leading horses or dogs, made up of at least one fastening element and one line element. Furthermore, the leash features a flexible sliding handle element surrounding the line element.

### BACKGROUND OF THE INVENTION

Leashes for leading animals such as horses or dogs are made of various materials, e.g. nylon, wool, hemp, natural fibers or leather, that are fastened to a collar, harness or halter by means of a fastening element, e.g. a hook element made of plastic or metal or a similar material, and are known in the art.

Such leashes are guided through the palm of the hand and are enclosed by the fingers and thumb. This creates immediate contact between the line element of the leash and the palm and the fingers and the thumb of the hand. For loading horses or for leading them temporarily, short leashes, or tethers, with a length of 1.5 to 3 meters are frequently used, being fastened directly to the halter of the horse by means of a hook-shaped fastening element. Furthermore, leashes or lunging lines with a length of 5 to 15 meters are known for lunging horses in the paddock.

Frequently, however, the horse will shy while being led and will pull its head to the side, thus jerking the leash. The person leading the horse is surprised by the jerking motion of the horse and has practically no time to react, i.e. to release the handle on the leash or lunging line. The delayed release of the leash and the horse's jerking on the leash cause a considerable section of the leash, for example approx. 1 meter or more, to be pulled through the hand of the person leading the horse. This sudden jerking motion and the considerable length of the section of the leash pulled through the hand frequently cause burns on the palm of the hand or individual fingers. In some cases painful grazing of individual parts of the palm of the hand can occur, requiring medical treatment.

It is an object of the present invention is to provide a leash, in particular for horses, dogs or similar animals, which eliminates the above disadvantages.

### SUMMARY OF THE INVENTION

The leash according to the invention features, in addition to a line element connected to a fastening element, a flexible sliding handle element surrounding the line element. The sliding handle element forms a grip, which can slide along the leash and which, especially in case of sudden pulling on the leash, allows the line element to slide through the guide channel of the sliding handle, without the hand of the person leading the horse being burned or injured by such sudden movement.

### BRIEF DESCRIPTION OF THE INVENTION

The invention is described below in more detail based on several exemplary embodiments with reference to the corresponding drawings, wherein:

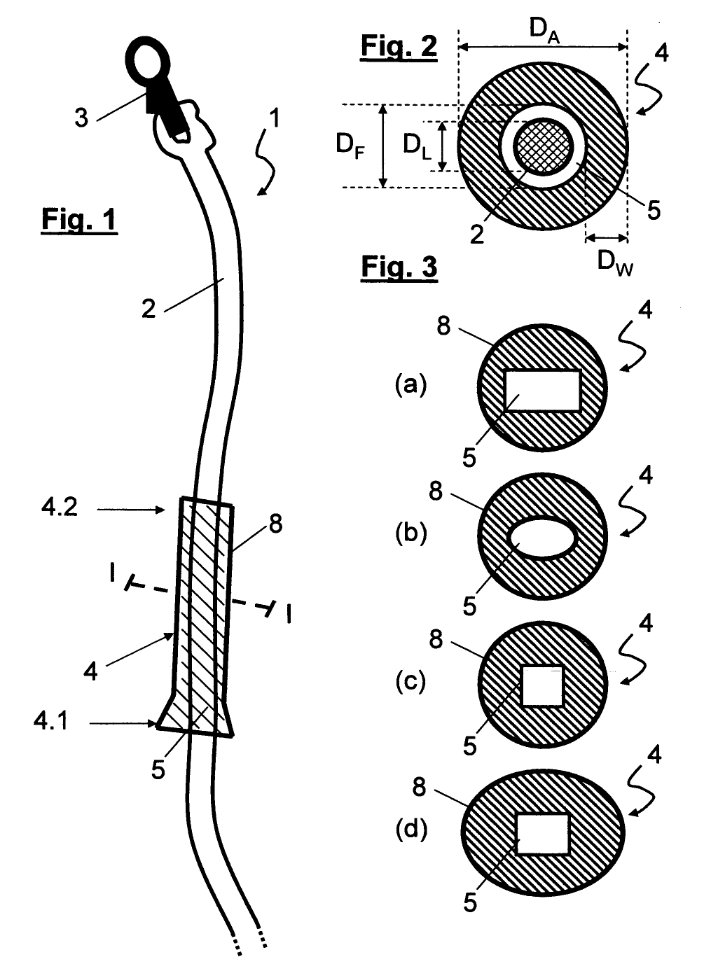

FIG. 1 shows by way of example the leash according to the invention in side view;

FIG. 2 shows a section along the line 1-1 through the flexible sliding handle element of the leash according to the invention in FIG. 1;

FIG. 3 shows by way of example a cross-sectional view of several alternative embodiments of the flexible sliding handle element;

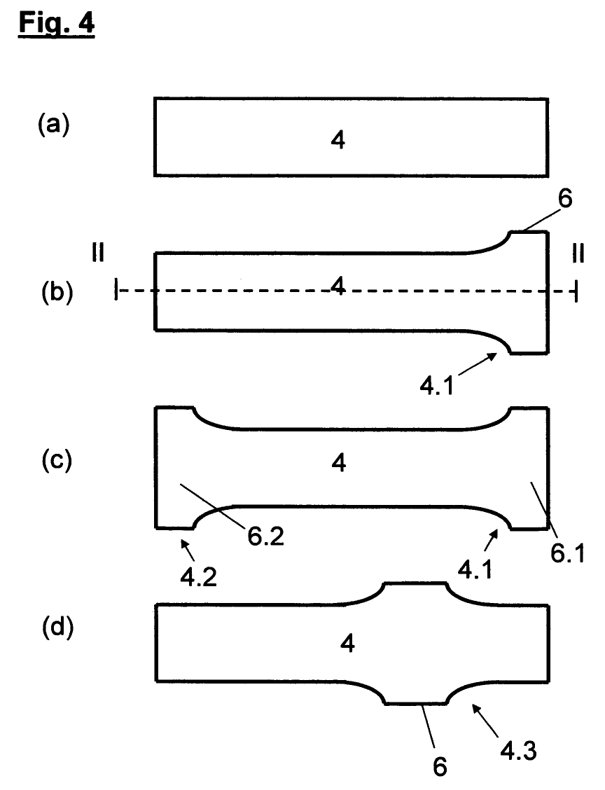

FIG. 4 shows by way of example a side view of several alternative embodiments of the flexible sliding handle element;

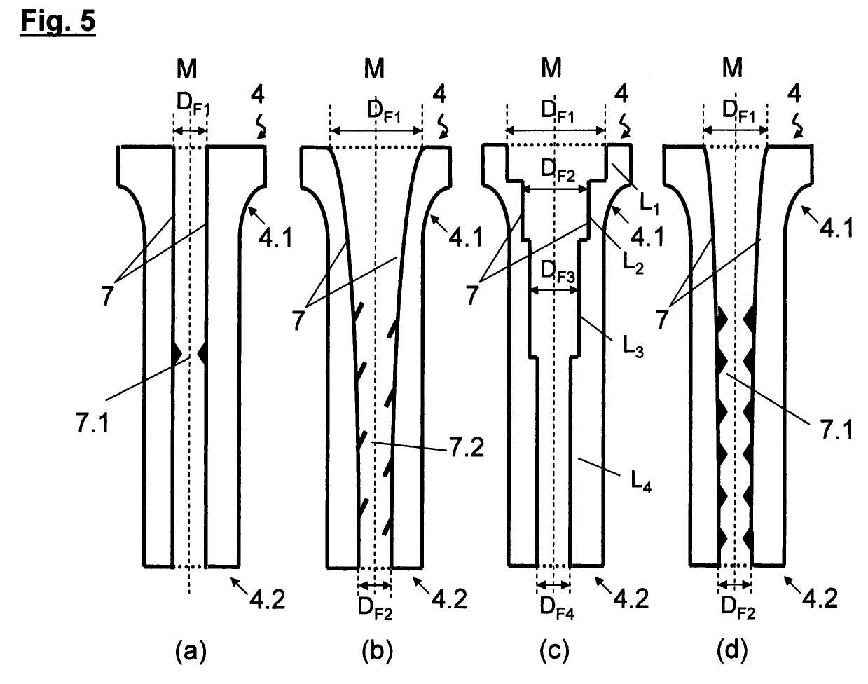

FIG. 5 shows by way of example a longitudinal section along the line 11-11 of various embodiments of the guide channel of the flexible handle element; and

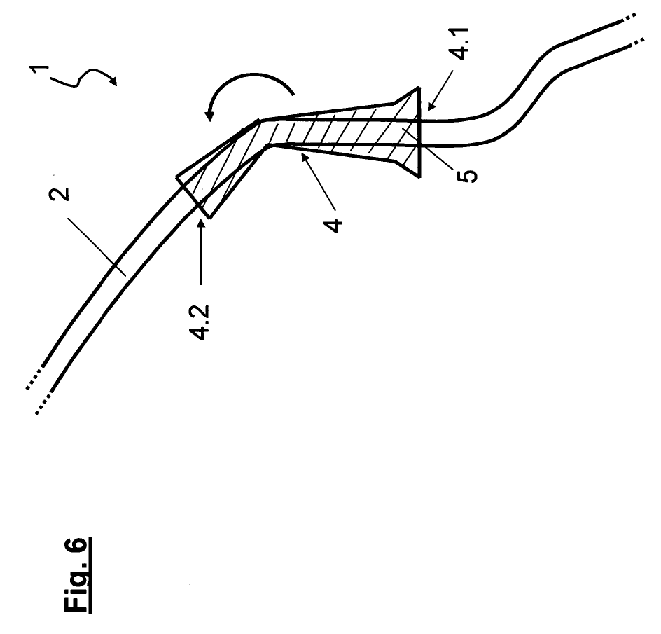

FIG. 6 shows by way of example a flexible sliding handle element fixed to the leash by bending.

### DETAILED DESCRIPTION OF THE DRAWINGS

In the drawings, reference numeral 1 generally designates a leash, in particular a horse or dog leash, which by way of example includes a line element 2 and a fastening element 3 that is connected to the line element. The fastening element 3 can be as a hook element made of plastic or metal. The line element 2, designed as a rope or cord, of the leash 1 features a flexible sliding handle element 4 surrounding the line 2.

The flexible sliding handle element 4 is designed as a sleeve or a hollow cylinder and has a guide channel 5 extending along the middle axis M for guiding the line 2. The diameter D_{F} of the guide channel 5 is adapted to the line diameter D_{L} or is selected so that the flexible sliding handle element 4 is held on the line 2 but can also slide along the line 2. For example, the guide channel 5 has a diameter D_{F} between 8 mm and 25 mm. The wall thickness D_{W} of the flexible sliding handle element 4 can vary between 5 mm and 25 mm depending on the outer shape and cross section of the flexible sliding handle element 4. Furthermore, the length of the flexible sliding handle element 4 is between 10 and 30 cm.

Furthermore, the flexible sliding handle element 4 has a surface 8 that extends concentrically to the middle axis M, whereby in one embodiment the outer diameter D_{A} of the flexible sliding handle element 4 is constant along the middle axis M at least in sections. This results in a tube-shaped or hollow cylinder-shaped sliding handle element 4 at least in sections (see FIG. 4a). In a preferred embodiment, the surface 8 of the sliding handle element 4 has a non-slip design, i.e. different profiles, recesses and/or material or fabric layers are provided on the surface 8 of the flexible sliding handle element 4 to increase the non-slip properties.

In an alternative embodiment, a bulge 6, 6.1, 6.2 is provided on at least the first or second free end 4.1, 4.2 or in the edge area 4.3 of the flexible sliding handle element 4, the diameter D_{RW} of said bulge being greater than the outer diameter D_{A}. This produces resistance against the direction of pull, preventing the hand surrounding the flexible sliding handle element 4 from slipping. For this purpose the flexible sliding handle element 4 is pushed onto the line element 2 so that for example the free end 4.1 of the flexible handle element comprising the bulge 6 points away from the fastening element 3, whereas the second free end 4.2 points toward the fastening element 3. Alternatively, a bulge 6.1, 6.2 can also be provided on the second free end 4.1, 4.2 of the flexible sliding handle element 4.

The flexible sliding handle element 4 is made for example of plastic, leather, rubber or a similar flexible material and is manufactured as one piece. Especially if plastic is used, it should have a shore hardness of less than 35. However, the flexible sliding handle element 4 can be made of several pieces, consisting of individual handle elements that are movably connected with each other and that are made from one of the aforementioned flexible materials or of a combination of these or in combination with additional materials such as wood, metal, plastic, etc.

The guide channel 5 can feature various designs. For example, the cross section of the guide channel 5 can be round, rectangular, oval, triangular, rhomboid or square (see FIG. 3a-3d). The cross section of the guide channel 5 can also be polygonal. In particular, the guide channel 5 can feature protruding anchoring elements 7.1, 7.2 on its inner surface toward the middle axis M of the rod-shaped sliding handle element 4, for increasing the friction between the line element 2 and the flexible sliding handle element 4. The anchoring elements 7.1, 7.2 can be designed for example as burl elements 7.1 or hook-shaped elements 7.2. In a preferred embodiment according to FIG. 5(a), the rod-shaped sliding handle element 4 features at least two burl elements or bulges 7.1.

Furthermore, the longitudinal section of the guide channel 5 has a cylindrical (see FIG. 5a) or a funnel-shaped form (see FIGS. 5b and 5d) along a sectional plane extending parallel to the middle axis along the line 11-11. In an alternative embodiment according to FIG. 5c the guide channel 5 can have a step-shaped design, i.e. the guide channel 5 comprises several guide channel sections 5.1, 5.2, 5.3., 5.4, each of which has a different diameter D_{F1}, DF_{F2}, DF_{F3}, DF_{F4} and/or different lengths L₁, through L₄. In both the funnel-shaped and the step-shaped embodiment of the guide channel 5, the respective diameter D_{F1}, D_{F2}, D_{F3}, D_{F4} decreases from the first to the second free end 4.1, 4.2.

Due to the flexible design of the sliding handle element 4, the flexible sliding handle element 4 can be fixed to the line element 2 designed as a rope or cord by bending the sliding handle element 4, as illustrated in FIG. 6. A simple, smooth bending movement, preferably in the section of the sliding handle element 4 facing the fastening element, can be used to fix the sliding handle element 4 more firmly on the line element 2, making it possible to securely hold a horse, for example.

The line element 2 can be made of various materials, such as nylon, (braided) wool, leather, hemp or other natural fibers and/or can be made of several different sections. For example, a first section of the line element 2 of the leash 1 can be designed as a chain element, whereby the second section accommodating the flexible handle element 4 is made of one of the materials described above.

The invention was described above based on exemplary embodiments. It goes without saying that numerous variations and modifications are possible without abandoning the inventive idea upon which the invention is based. For example, two flexible sliding handle elements 4 can be provided for each line element 2 in order to increase the holding force.

### REFERENCE LIST

1 leash
2 line element
3 fastening element
4 flexible sliding handle element
4.1 first free end
4.2 second free end
4.3 edge area
5 guide channel
6, 6.1, 6.2 bulge
7 inner surface of guide channel
7.1 anchoring elements
7.2 anchoring elements
8 surface of sliding handle element
M middle axis
D_{A} outer diameter
D_{F} diameter of guide channel
D_{F1} diameter of one first section of guide channel
D_{F2} diameter of one second section of guide channel
D_{F3} diameter of one third section of guide channel
D_{F4} diameter of one fourth section of guide channel
D_{L} diameter of line
D_{RW} diameter of bulge
D_{W} wall thickness
L₁-L₄ respective length of first—fourth section

What is claimed is:

1. A leash, for horses or dogs, comprising of at least one line element and one fastening element connected with the line element, wherein the leash features a flexible sliding handle element surrounding the line element.

2. The leash according to claim 1, wherein the flexible sliding handle element comprises at least one guide channel for accepting at least one section of the line element.

3. The leash according to claim 2, wherein the flexible sliding handle element forms a slidable handle, which is connected with the line element by means of the at least one guide channel.

4. The leash according to claim 1, wherein the flexible sliding handle element comprises a ring-shaped bulge, which is provided on at least one free end or in one edge area of the flexible sliding handle element.

5. The leash according to claim 1, wherein at least two anchoring elements, protruding radially inward, are provided on an inner surface of the flexible sliding handle element.

6. The leash according to claim 2, wherein the guide channel has a rectangular, round, oval, triangular, rhomboid, square or polygonal cross section.

7. The leash according to claim 2, wherein the guide channel has a cylindrical, funnel-shaped or step-shaped form extending along the middle axis (M) of the flexible sliding handle element.

8. The leash according to claim 1, wherein the line element is made of nylon, leather, braided wool, hemp or another natural fiber.

9. The leash according to claim 1, wherein the flexible sliding handle element is made of plastic, leather, rubber or a similar flexible material.

10. The leash according to claim 1, wherein the flexible sliding handle element is one piece or several pieces.

11. The leash according to claim 1, wherein the flexible sliding handle element is made of a combination of at least two flexible materials or one flexible and one non-flexible material.

12. The leash according to claim 1, wherein the leash has at least two flexible sliding handle elements.

13. The leash according to claim 1, wherein the line element of the leash has several sections, whereby at least one section is a chain element.

14. The leash according to claim 1, wherein the flexible sliding handle element has a non-slip surface.
